(19) United States
(12) Patent Application Publication
(10) Pub. No.: US 2015/0008092 A1
(43) Pub. Date: Jan. 8, 2015

(54) LOCKING UNIT, IN PARTICULAR FOR A PARKING LOCK OF AN AUTOMATIC TRANSMISSION

(71) Applicant: SVM Schultz Verwaltungs-GmbH & Co.KG, Memmingen (DE)

(72) Inventors: Helmut Mang, Memmingen (DE); Georg Scherer, Kirchheim (DE)

(21) Appl. No.: 14/383,198

(22) PCT Filed: Mar. 5, 2013
(86) PCT No.: PCT/EP2013/054443

§ 371 Date: Sep. 5, 2014

(30) Foreign Application Priority Data
Mar. 5, 2012 (DE) 10 2012 004 159.4

(51) Int. Cl. F16D 63/00; B60T 1/00

(52) U.S. Cl. CPC F16D 63/006; B60T 1/005
USPC 192/219.4

(57) ABSTRACT

The invention relates to a locking unit, in particular for a parking lock of an automatic transmission, for locking the motion of a piston that can be moved by a drive, in particular a piston to which pressure can be applied, wherein the locking unit has an electromagnet and at least one catch element and the catch element interacts with the armature or armature rod of the electromagnet or with a bolt or bolt ring retained by the armature or armature rod or arranged on the armature or armature rod and the piston has at least two catch receptacles at a distance from each other and the piston can be fixed in different positions of the piston by the stopping interaction of the catch element with the respective catch receptacle. The invention further relates to a transmission equipped with the locking unit.

The invention relates to a locking unit, in particular for a parking lock of an automatic transmission, for locking the movement of a piston that can be moved by a drive, in particular a piston to which pressure can be applied, wherein the locking unit has an electromagnet and at least one catch element, and the catch element interacts with the armature or the armature rod of the electromagnet or with a bolt retained by the armature or the armature rod.

The aforementioned locking units are used in particular for the parking lock of automatic transmissions. Here, the system pressure of the hydraulic circuit of the automatic transmission is used for driving a movable piston.

By engaging a gear, a vehicle having a manual transmission can be secured against unintentional rolling away at standstill when the engine is turned off. However, this is not possible for automatic transmissions since there is no frictional connection to the driven wheels when the engine is turned off. Thus, automatic transmissions have a mechanical locking of the transmission output shaft which has to be activated, that is, to be engaged in the parking position so as to prevent the vehicle from rolling away.

Here, the locking unit interacts with the hydraulic circuit of the automatic transmission. When the parking lock is engaged, it is normally provided that the piston is unlocked. In the driving position, thus when the parking lock is turned off, the moving piston, in particular pressurized piston is locked. Usually the piston rod of the piston acts on a blocking unit which engages in a suitable manner with the drive train, or does not engage, depending on the position of the parking lock.

A generic locking unit can be found, for example, in the European patent specification 1 408 260.

From the prior art, only such locking unit are known which define, thus fix, the position of the piston in one place. However, it would be desirable to have a locking unit that allows locking, that is, fixing the piston in a plurality of different positions.

It is therefore an object of the invention to improve a locking unit as known in such a manner that fixing the piston in a plurality of positions is possible.

In order to achieve this object, the invention refers to a locking unit as described above and proposes that the piston has at least two catch receptacles that are spaced apart from each other and the piston can be fixed in different positions of the piston by the stopping interaction of the catch element with the respective catch receptacle.

By the proposal according to the invention it is possible that the piston can be fixed in different axial positions. The axial position is defined here by the direction of movement of the piston; in this respect, the direction of movement defines the axis. By suitably arranging two or even more catch receptacles on the piston, it is possible to achieve a mechanically fixed locking of the piston in any number of positions.

In a preferred configuration of the invention there a multiple variants as to how the arrangement of the catch receptacles is formed on the piston.

In a first variant, the piston head is equipped with a plurality of catch elements arranged axially one behind the other, and the catch element of the locking unit engages radially from the outside inwards on these catch receptacles. Advantageously, the piston head is arranged centrally or centrically with respect to the symmetry axis of the piston.

In another variant according to the invention, which is also shown in the drawing, the piston has a catch sleeve that has a plurality of catch receptacles on its inner shell surface.

In this variant of the locking unit according to the invention, the catch element or the catch elements extend into the recesses of the sleeve. Here, for example, the sleeve is integrally connected to the piston and is implemented as a blind hole by centric drilling, for example. The catch receptacles are formed as laterally extending circumferential grooves. For connecting or fixing the piston, the catch element is moved radially outwards whereby the latch engages in the catch receptacle at the catch element.

A substantial advantage of the invention is in particular that through the configuration of the catch element, in particular due to the flat configuration of the latch at the catch element, excessive material stress in the catch element is avoided since the load is applied extensively on the catch element and does not act as point loading.

The locking unit according to a preferred embodiment provides that the catch receptacles are arranged axially spaced apart on the piston. Here, the spacing depends in each case on the geometry defined by the piston or on the size of the locking unit and the associated optionally different lengths of the piston. The catch receptacles can be arranged uniformly spaced apart on the piston, that is, they can be arranged at equal distances from each other, or they can be arranged at different distances. This also depends on the size of the automatic transmission to be equipped with the locking unit. The arrangement of a plurality of catch elements that are axially spaced allows in addition an adaptation to different automatic transmissions and automatic transmission sizes and therefore simplifies the fabrication of the locking unit and, at the same time, increases its usability significantly.

It is regarded to be advantageous if the piston has an axial extension, in particular a piston head, which comprises the catch elements and is in particular aligned in the direction of the electromagnet. This extension having or providing the piston head can advantageously be formed as a separate element that can be connected to the piston, or can be formed as an element that is integrally connected with the piston or projects from the piston.

The extension is preferably formed as a catch sleeve having an inner shell surface. In this connection, the catch receptacles are provided as recesses incorporated in the inner shell surface. With regard to the configuration of the recesses, there are many different possibilities. Thus, for example, just a cut in the shell surface can serve as the recess. At the same time, there is the possibility here that ring grooves or half-ring grooves are incorporated in the inner shell surface, which grooves then serve as recess. The ring or half-ring grooves can have a round or an angular cross-sectional shape. Of course, there is also the possibility here that a triangular cut-out or cut is incorporated in the inner shell surface and thus the recess is provided.

In an alternative embodiment it is provided that the catch sleeve is provided by a separate element attached to the piston, or is provided as a blind hole that is drilled centrically into the piston or piston head. This means, the piston is made, for example, from solid material and the catch sleeve is then countersunk therein, for example by cutting or drilling a blind hole. The inside of the hole then provides the inner shell surface of the catch sleeve in which, in turn, the recesses or catch receptacles are incorporated, which then can interact with the catch element.

In another embodiment variant of the locking unit according to the invention it is provided that the extension is formed as an axially extended piston head with an outer shell surface. In this case, the catch receptacle is implemented as a recess incorporated in the piston head made from solid material or in the outer shell surface thereof. Likewise, a plurality of catch receptacles are comprised which are incorporated in the piston head or the outer shell surface thereof. Here too, there is the possibility that the recesses are provided as ring grooves or half-ring grooves. Likewise, the recesses can also be formed as simple cuts or recesses in the piston head or the outer shell surface thereof. The geometry of the ring grooves or half-ring grooves or other recesses is also variable and can be formed semi-circular, angular, triangular or in any other suitable manner that is also adapted to the catch element or the latch-like bending provided there.

The catch element that interacts with the catch receptacles of the outer or inner shell surface of the piston head is advantageously formed as a resiliently mounted tongue that extends in the axial direction of the piston into the piston at least up into the region of the catch receptacles. The elastically resilient mounting of the catch element allows that it can be acted on by the bolt and enables at the same time that upon interruption of the current supply to the electromagnet and the resulting return movement of the armature with the bolt arranged thereon, the catch element is moved back into an initial or starting position in order to then effectively lock or block the piston. The elastically resilient mounting of the catch element or of the tongue forming the catch element enables the movement even without additional external influences, such as, for example, a magnetic force or the like.

The catch element is preferably formed to be elastically deformable and therefore can be automatically moved back or can spring back into the initial position or a starting position.

The elastic deformability or the elastically resilient mounting of the catch element is in particular facilitated in that it is made from spring steel. Spring steel has the advantage, for example, that it is plastically deformable when cold; however, when in use or in the installed state, it allows several cycles of elastic deformation and therefore provides for a durable catch element.

The catch element in the locking unit according to the invention is preferably formed in such a manner that at that free end of the catch element that is closest to the catch receptacles, at least one latch-like bending is provided that extends radially in the direction of the catch receptacles. This latch-like bending is pressed in a locking or securing position into the catch receptacles by means of the bolt provided on the armature rod, and secures there the locking unit.

In an alternative embodiment it is provided that the catch element has a suitable preload so that at the end of the pressure application on the catch element by the bolt, automatic spring-back into the locking position takes place.

The latch-like bending on the catch element is preferably formed to be flat and is in engagement with at least one catch receptacle that has a matching size or width. In this connection it is regarded to be advantageous if the length of the latch-like bending corresponds substantially to the depth of the catch receptacles. The full-surface contact of the latch-like bending on or in the catch receptacle results in an advantageous force distribution and therefore in a secure operation of the locking unit.

An advantageous refinement of the locking unit according to the invention provides that in the case of a de-energized electromagnet, the bolt can be positioned in such a manner that the catch element can be brought from a locking position into an unlocking position of the locking unit. In contrast, in the case of an energized electromagnet, the bolt acts on the catch element in such a manner that the latter can be brought from an unlocking position into a locking position. By axially displacing the bolt, in one embodiment, the catch element is moved radially outwards so as to be brought in engagement there with the catch receptacles. In another variant of the invention it is provided that the bolt acts onto the catch element in such a manner that in the energized state, the latch-like bending is moved out of the catch receptacles due to the radial displacement or pivoting of the catch element. Both embodiment variants are comprised by the invention. While in the de-energized state, in a first variant of the locking unit according to the invention, the bolt is positioned such that due to the preload of the catch element, the latter is in engagement with the recess in the piston head, it can alternatively also be provided that in the de-energized state of the electromagnet, the bolt is positioned such that the latter is not engaged with the catch element and, due to the preload, the catch element is therefore lifted out of the catch receptacle and thus releases the latter. In the first-mentioned case, the catch element has a suitable shape, for example, has a projection or a thickening that establishes an operative connection with the bolt.

It is regarded to be advantageous if the catch element has a preload which, viewed relative to the longitudinal axis of the piston, is directed radially outwards or radially inwards. This facilitates the actuation of the catch element and the engagement with the catch receptacles or the interaction with the displaceably mounted bolt that is attached on the armature of the electromagnet.

In another embodiment of the locking unit according to the invention it is provided that when the electromagnet is energized, the bolt or bolt ring can be positioned in such a manner that the catch element can be brought from a locking position into an unlocking position, and when the electromagnet is de-energized, the bolt or bolt ring can act on the catch element in such a manner that the catch element can be brought from an unlocking position into a locking position. In this case, lifting the catch element or the latch arranged thereon out of the locking position is achieved by means of the energy-induced displacement of the armature in the electromagnet and the resulting movement of the bolt. When energization of the electromagnet is stopped and the armature drops off the electromagnet, the bolt is displaced relative to the catch element and brings the catch element into engagement again with the catch receptacle and thus achieves locking of the piston. The return spring which, in a refinement of the invention, is associated with the bolt, bolt ring and/or the armature rod then effects in the de-energized electromagnet a return movement of the bolt and/or armature into the locking position of the catch element. In the energized state of the electromagnet, the return spring can preferably be compressed by the armature movement; however, in the de-energized state of the electromagnet, the return spring introduces a reset force into the armature, which reset force is directed away from the electromagnet in the axial direction, and thereby moves the bolt or bolt ring, as a result of which the catch element is brought into engagement with the catch receptacle.

In this connection, it is regarded to be advantageous if in a first catch position, an axial movement of the piston towards the electromagnet can be blocked and if in a second catch position, an axial movement of the piston away from the electromagnet can be blocked. For this purpose, the piston has correspondingly positioned catch receptacles which, depending on the position of the piston, can be brought into engagement with the catch element.

The catch element is preferably formed to be rigid or elastic, in particular with or without preload, and thus, depending on the bolt configuration, it can independently spring into the catch position or, due to the preload, can be automatically lifted out of the catch position.

A refinement of the invention that is regarded to be favorable provides that two or more catch elements are provided which are coaxial with the bolt or the bolt ring. This proves to be of advantage in particular if the piston or piston head is formed cylindrically and provides an inner surface in which the catch receptacles are arranged which then are brought into engagement with the catch elements or with the latch-like bendings or latches arranged thereon.

The bolt or bolt ring advantageously has a circumferentially extending projection or flange that can be brought into operative connection with a cam arranged on the catch element. It is regarded to be an advantageous refinement if the projection or flange is formed conically and slides particularly easily onto the cam provided on the catch element, or can slide over the cam in order to actuate the catch element, in particular to bring it into the catch position or locking position or to lift it out from this position.

In a preferred refinement, the locking unit according to the invention provides that the return spring is supported on the one side on the electromagnet or on or in the yoke of the electromagnet, and on the other side, it is supported on the bolt, bolt ring or a projection or flange provided on the bolt or the bolt ring. Through this, a particularly favorable spring guidance and therefore a satisfactory function of the return spring is achieved, namely to carry out the actuation of the bolt or bolt ring and thus to achieve actuation of the catch element.

It is regarded to be favorable if the armature rod has a circumferentially extending edge against which the bolt or bolt ring rests. Through this, a locating surface for the bolt or bolt ring is created and the bolt is prevented from being displaced on the armature rod in the axial direction. The projection or flange can be formed on the armature rod or can be formed into the armature during the manufacture thereof.

An advantageous refinement provides that the catch element provides a surface that is in operative connection with the bolt, and when the bolt moves in the axial direction of the locking unit, the catch element can be moved at or via said surface, the catch element or the latch-like bending into or out of the catch receptacle.

In the locking unit according to the invention or a preferred embodiment thereof it is provided that the bolt has a bolt tip that conically tapers in the direction of the armature rod. The conically tapering bolt tip rests against the surface, and when the bolt tip moves via the surface or a surface portion in the axial direction of the locking unit, a movement of the catch element takes place which movement, with regard to the longitudinal axis of the piston, is directed radially outwards; the axial movement of the bolt is therefore converted, against the preload of the catch element, into the radial movement of the catch element.

Furthermore, it is regarded to be favorable if the catch element has a thickening, in particular a conically formed thickening that can be brought into engagement with the bolt or the bolt tip. A relative movement of bolt or bolt tip and thickening is converted here, with regard to the longitudinal axis of the piston, into an outwardly directed radial movement of the catch element or the latch-like bending. The catch element is in particular moved against the preload of the catch element, and lifting of the latch-like bending from or out of the catch receptacle takes place.

The catch element is advantageously resiliently hinged in the locking unit, in particular in the region of that end of the locking unit that lies diametrically opposite the piston rod. In this connection, it is regarded to be favorable if a hinge point is provided on the electromagnet extending into the locking unit or on a yoke that closes the electromagnet in the direction of the locking unit. There, the catch element can be secured, for example, via a cotter pin, by spot bonding or spot welding or in any other manner that is suitable and known to the person skilled in the art in such a manner that resilient movement of the catch element still remains possible.

The yoke closing the electromagnet or the locking unit preferably has a recessed circumferential region at which the hinge point is provided.

A favorable refinement of the locking unit provides that the latch-like bending extends radially in the direction towards the piston center, or, in an alternative embodiment, extends radially away from the piston center. In another favorable embodiment, the locking unit provides that a movement of the bolt or bolt head can be converted into a radial movement of the catch element, and depending on the preload of the catch element, the latch-like bending can be brought from a locking position into a release position, or is moved from a release position into a locking position. Both embodiment variants are comprised by the invention. The configuration of the piston or the piston head and the provided arrangement of the catch receptacles are crucial for the selection of the embodiment variant.

In an advantageous refinement, the bolt has a return spring that acts against the armature movement of the electromagnet. Through this it is achieved that at the end of the energization of the electromagnet, the armature and thus the bolt is moved back in a rest position or starting position. Depending on the configuration of the locking unit, this return movement effects a movement of the catch element. Depending on the preload of the catch element, the catch element then moves relative to the catch receptacles.

The reset force of the spring is supported by the resilient mounting of the catch element which, upon dropping of the armature, acts on the bolt, which now can be moved in the axial direction, and pushes the bolt into the starting or rest position. This is supported by the angled surfaces of the conically formed bolt, which surfaces are in operative connection with the catch element or are guided by the latter.

The invention also comprises a transmission, in particular an automatic transmission with a parking lock having a locking unit configured as described above. The invention is schematically illustrated in the drawing in particular in an exemplary embodiment. In the figures:

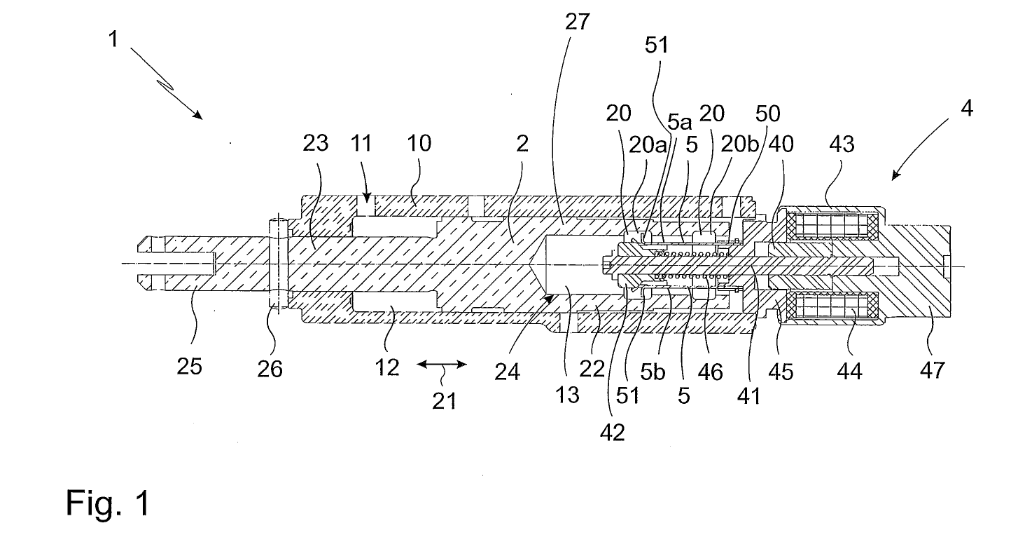

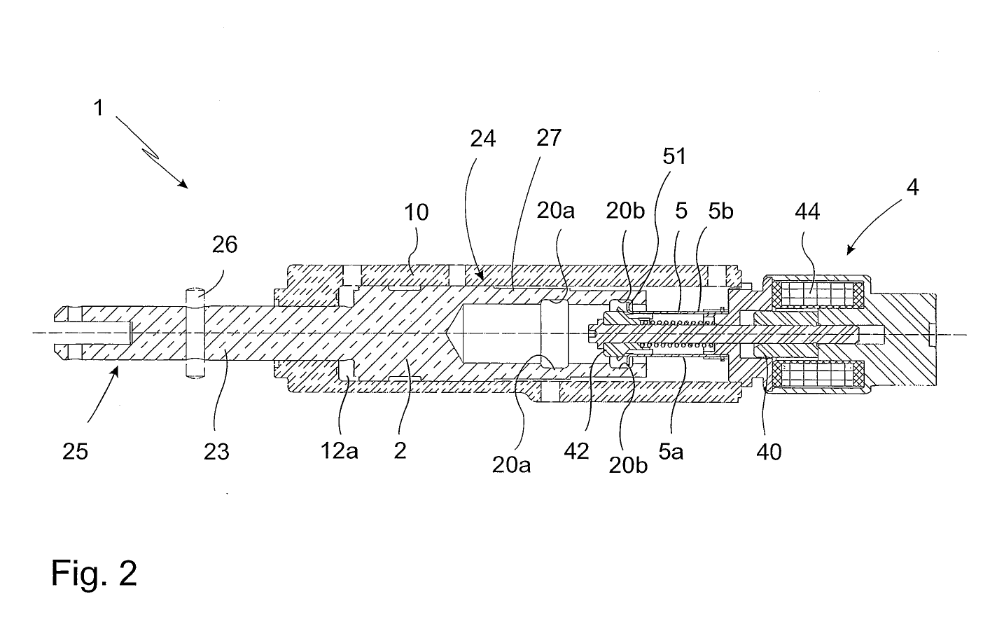

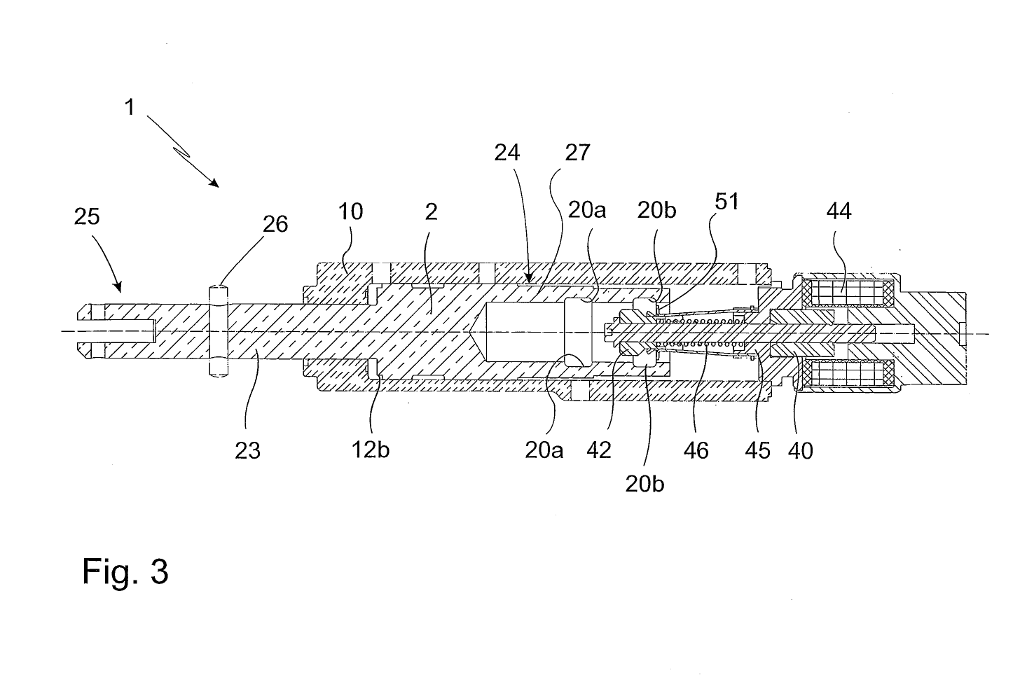

FIG. 1, FIG. 2, FIG. 3 show a sectional view of a locking unit according to the invention in different positions;

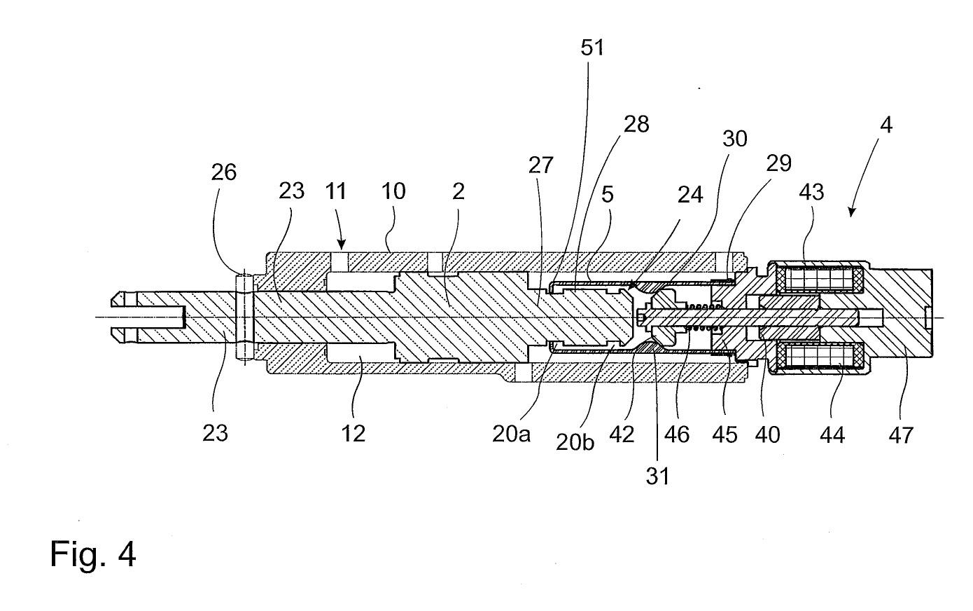

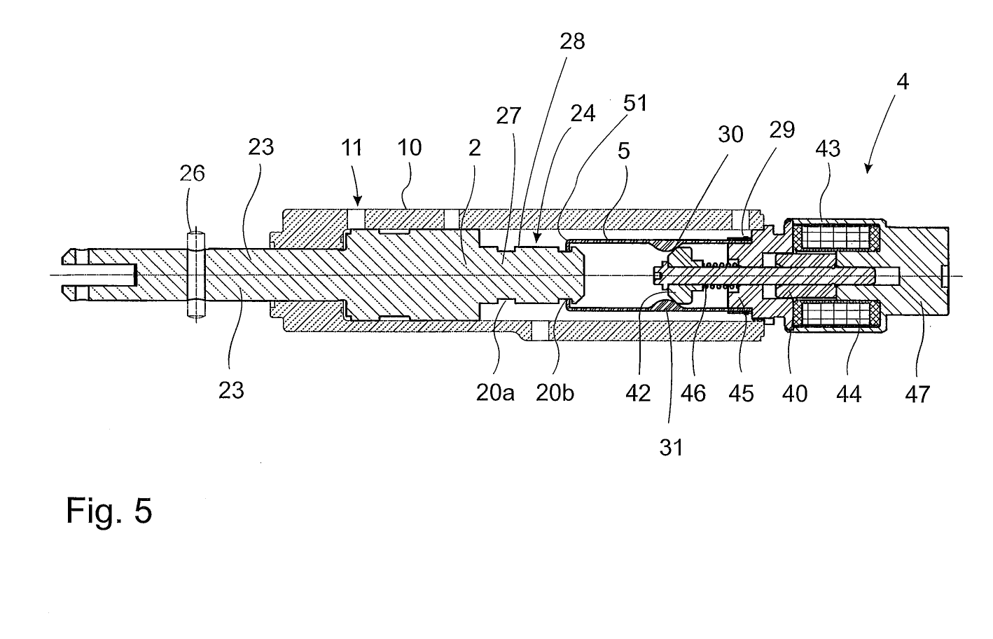

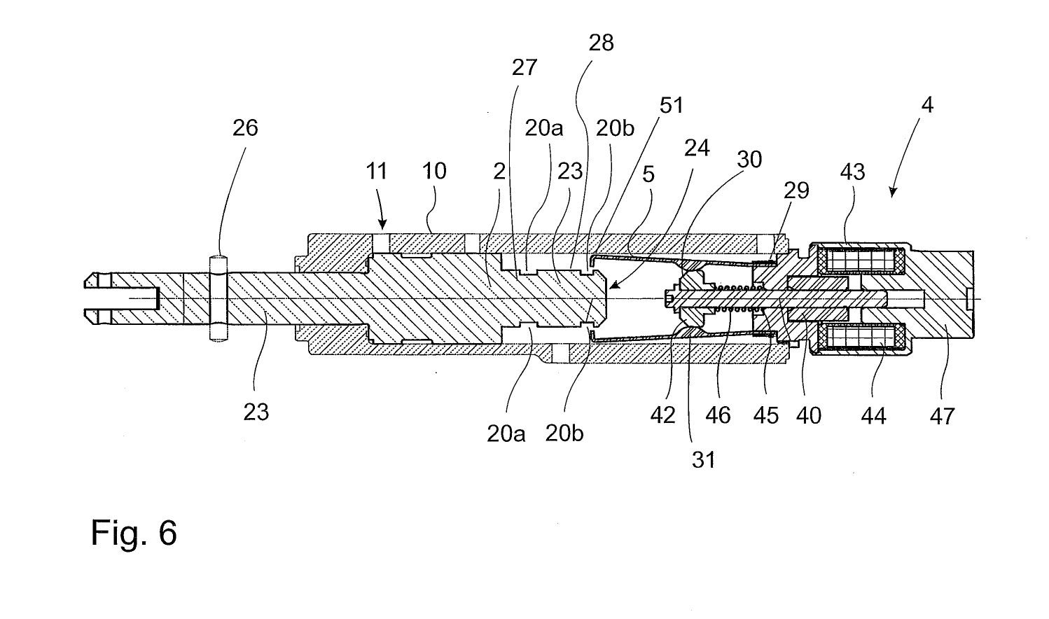

FIG. 4, FIG. 5, FIG. 6 show another possible embodiment of the locking unit;

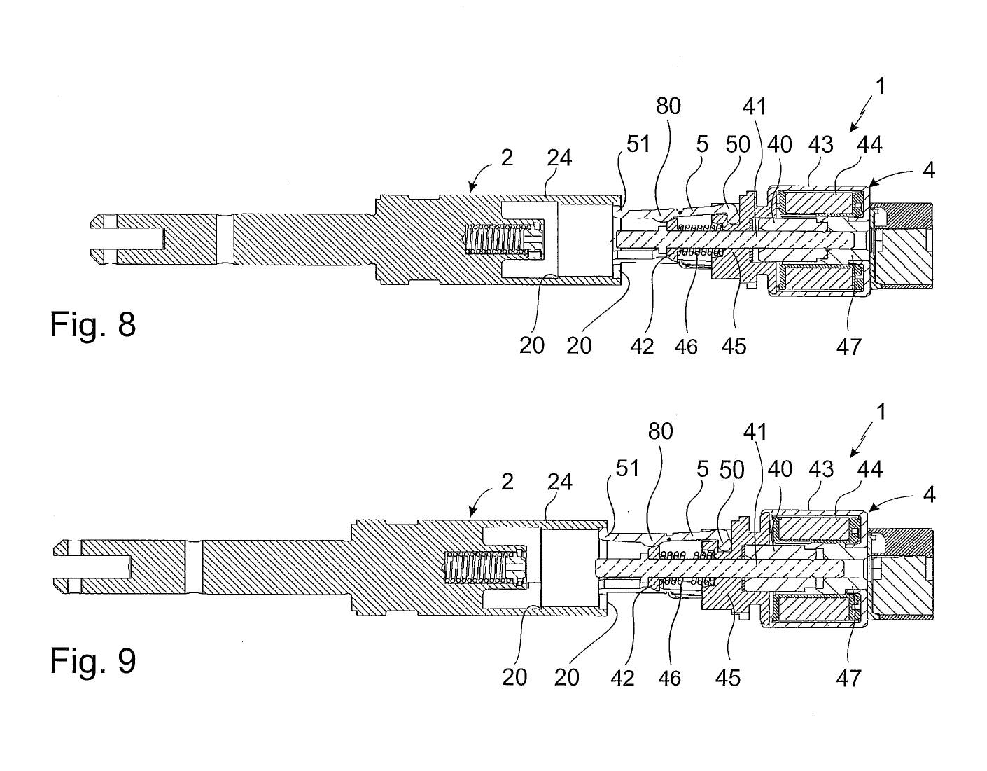

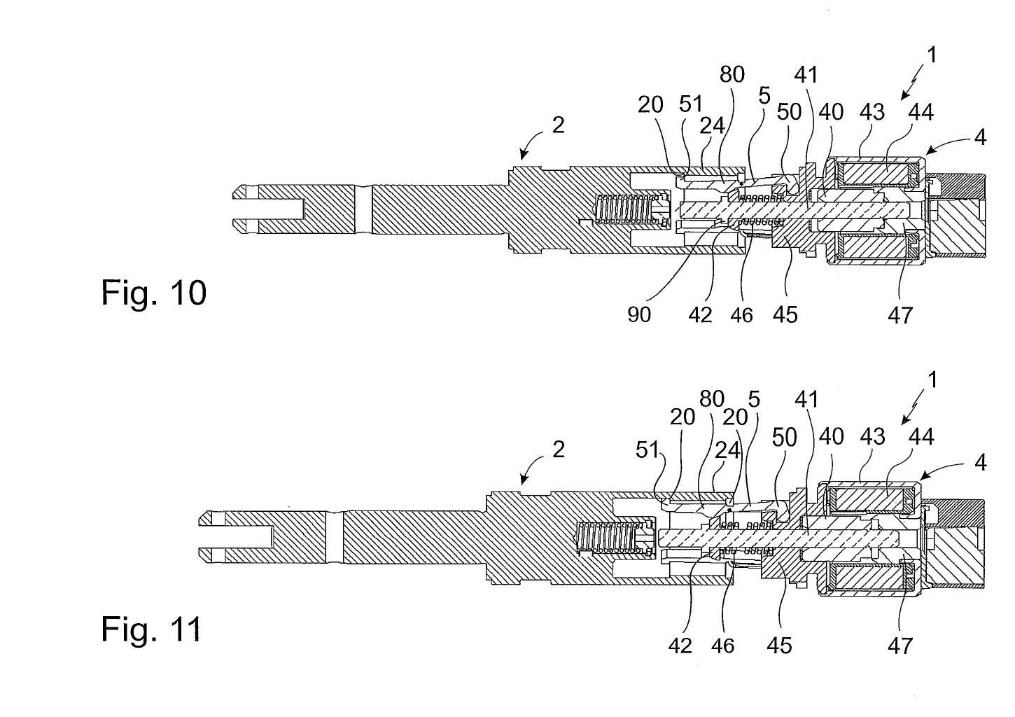

FIG. 8, FIG. 9 show another possible embodiment of FIG. 10, FIG. 11 the locking unit in different positions.

In the figures, the same elements or elements corresponding to one another are designated by the same reference number and are therefore not described again, unless it is useful.

In FIG. 1, the schematic construction of a locking unit 1 according to the invention is schematically illustrated. The locking unit 1 consists of a housing 10 that accommodates the piston 2. The piston 2 is movably mounted in the housing 10. The piston 2 can be pressurized via the connection line 11 and the pressure chamber 12 with pressure from a hydraulic circuit, for example of an automatic transmission, in such a manner that the piston 2 can be moved, e.g., to the right, as indicated by the double arrow 21.

On one side, the housing 10 has a hole through which the piston rod 23, which forms the piston 2, is guided to the outside. On its side facing away from the piston head 24, the piston rod 23 carries, for example, a blocking element 25 that effects a mechanical locking of the transmission in the parking position.

On the side opposite to the hole accommodating the piston rod 23, the housing 10 is closed by the attached electromagnet 4. Here, the electromagnet 4 itself has a suitable coil housing 43.

As usual, the construction of the electromagnet is characterized by a coil 44 that carries the windings of a wire through which electric current can flow.

An armature 40 extends at least partially into the inside of the coil 44. The armature 40 is mounted to be axially movable. Here, for example, the coil axis of the coil 44 is to be understood as the axis. In the direction of the piston 2, a yoke 45 is connected to the electromagnet 4, which yoke acts at the same time as axial guide of the armature 40. The yoke 45 has a hole through which the armature rod 41 protrudes from the inside of the coil towards the piston 2 or into the housing 10. The armature 40 is axially fixedly connected on the armature rod 41 in such a manner that the movement of the armature 40 is transmitted identically to the armature rod 41.

On the yoke side of the yoke 45 facing the housing interior 13, the catch element 5 is arranged in a movable manner, at least in a flexibly bendable or resiliently mounted manner. The catch element 5 can be pivoted here about the bearing point 50 or is at least flexibly deflectable. The catch element 5 extends into the housing interior 13, and the catch element 5, at its end facing away from the bearing point 50, carries an outwardly directed latch 51 or latch-like bending that is able to interact with a catch receptacle 20 of the catch sleeve 22 of the piston 2.

The armature 40 reacts to a magnet field. If the current through the coil windings of the coil 44 is now switched on, a magnetic field forms in which the armature 40 tries to orient itself. In the exemplary embodiment shown in FIG. 1, the current flow is switched on, the armature 40 is displaced to the right against the force of a return spring 46 and a possible air gap between the armature 40 and the core 47 is closed.

On its piston head 24, the piston 2 has an integrally arranged catch sleeve 22. This catch sleeve 22 is provided in the piston head 24, for example, by a blind hole which is arranged centrically with regard to the rotational axis or symmetry axis of the piston.

On the armature rod 41, at the end thereof, there is a bolt 42, the shell surface of which interacts in the region of the latch 51 with the inner side of the catch element 5. In the activated position of the locking unit, thus when the coil 44 is energized, the bolt 42 is displaced by the armature rod 41 in such a manner that the catch elements rest against the bolt, and due to the diameter of the bolt and the position of the catch element, the catch element is deflected outwardly. In this situation, the latch 51 then gets into engagement with a catch receptacle 20, 20a, 20b provided on the piston 2.

The catch receptacle 20, 20a, 20b is provided in a suitable manner on the piston, wherein in the exemplary embodiment shown here, the piston integrally carries a catch sleeve 22 which has an annularly extending circumferential groove-like catch receptacle 20, 20a, 20b. In the axial direction, with regard to the direction of movement 21, a plurality of catch receptacles 20a, 20b are provided here. When the locking unit is activated, the retracted bolt 42 pushes the latches 51 arranged at the end of the catch elements into the catch receptacles 20, resulting in corresponding fixing or blocking or locking of the piston 2 in the respective position.

The configuration of the piston 2 with a catch sleeve 22 has the advantage that a space-saving arrangement is implemented in this manner.

In the axial direction with regard to the direction of movement of the piston 2, a plurality of catch receptacles 20a, 20b are provided which are arranged axially offset from each other and which, if positioned in an adequate position relative to the catch element 5, is in stopping interaction with the latter, thereby blocking the piston 2.

In the exemplary embodiment shown in FIG. 1, the catch elements 5, 5a, 5b engage in the inner left catch receptacle 20a. Engaging takes place here such that the latch edge or the latch surface of the latch 51 rests against the groove wall of the groove-like catch receptacle 20, 20a, 20b in a holding manner and avoids further axial movement of the piston 2 to the left and also to the right, thus extending in or out of the housing 10. The resulting mobility in the locking position is given through the axial width of the groove-like catch receptacle 20.

For further mechanical relief of the strain on the individual catch elements 5 it is provided that the locking unit 1 according to the invention has a multiplicity of catch elements 5, 5a, 5b that are arranged equidistantly in the circumferential direction around the armature rod 41 with the same radial distance from each other. By a corresponding rotationally symmetric construction, consistent actuation of the individual catch element 5, 5a, 5b is also achieved by the lifting movement of the retracted bolt 42. It is also of essence in this arrangement that for the locking position, the catch elements 5, 5a, 5b are moved radially outwards. This movement takes place through the retraction movement of the piston 42 by energizing the coil 44. This linear movement is deflected by the conical or angular configuration of the bolt 42 in such a manner for the catch elements 5, 5a, 5b that the free ends of the catch elements that carry the latch 51, are moved outwards and thus engage in the catch receptacle 20, 20a, 20b.

In FIG. 2, another locking position of the locking unit 1 is shown; however, in a different position of the piston 2. The piston rod 23 is not completely extended into the housing 10 up to the locating pin, but only up to approximately half of it. It can clearly be seen that the pressure chamber 12a according to FIG. 2 has a shorter axial length than the pressure chamber 12 according to FIG. 1. In this slightly more extended position, the piston 2 is still locked in that the catch elements 5 engage in a stopping manner into the outer catch receptacle 20b arranged farther to the right or farther up or further out. In FIG. 2 as well, current is applied to the coil 44 whereby the armature 40 is displaced to the right and the retracted bolt 42 pushes the catch elements 5, 5a, 5b radially outwards into the catch receptacle 20b.

In FIG. 3, the third position of the locking unit 1 according to the invention is shown. The current through the coil 44 is switched off, the return spring 46, which is compressed between yoke 45 and bolt 42, is relaxed in such a manner that the armature 40 is shifted to the left until the armature 40 abuts against the yoke 45. As a result, the bolt 42 is also shifted so far to the left that the free end of the catch element 5, 5a, 5b does no longer project radially outward, but, due to the inherent elasticity, is directed inwards towards the armature rod 41. For this, the catch element 5, 5a, 5b has adequate elasticity. In this position, the piston rod 23 extends farther to the left out of the housing 10. The pressure chamber 12b according to FIG. 3 is even smaller; its axial length is significantly shorter than the pressure chamber 12a according to FIG. 2 or the pressure chamber 12 according to FIG. 1. In this completely unlocked position, for example, the blocking element 25 can engage in a suitable manner with the drive train and can form a parking position here.

In contrast to the previously described embodiment variants, the piston head 24 in the embodiment shown in FIGS. 4, 5 and 6 is formed as an extension of the piston rod 23 in the direction of the electromagnet 4. In the exemplary embodiment, the piston head has an outer shell surface 28 in which the catch receptacles 20, 20a, 20b are provided. The catch receptacles 20, 20a, 20b are formed as ring grooves. The catch element 5 in the exemplary embodiment of the FIGS. 4, 5 and 6 is likewise resiliently mounted in the housing 10. For this, the yoke 45 of the electric magnet 4 provides a hinge point 29 to which the catch element 5 is connected. The catch element 5 has a latch 51 that is formed as a latch-like bending of the catch element 5 and is in engagement with the catch receptacles 20, 20a, 20b, as shown in FIG. 4. Unlike the embodiments of the FIGS. 1 to 3, the latch 51, however, is directed radially inwards, that is, towards the piston center and is in engagement there with the catch receptacles 20, 20a, 20b. This is made possible through the configuration and arrangement of the bolt 42.

The latter is shown in FIG. 4 in the energized state. In this state, the armature 40 is attracted in the electromagnet 4 and the bolt thus is retracted with respect to the piston head 24. Due to the preload of the catch element 5, the latter deflects into the locking position, wherein the latch 51 is brought into engagement with the catch receptacles 20, 20a, 20b. The bolt 42 has a conical chamfer 30 that rests against a thickening 31 of the catch element 5. The thickening 31 is semi-circularly shaped and can establish an operative connection with the conical chamfer 30. This is in particular the case if, as illustrated in FIG. 6, the electromagnet 4 is de-energized and therefore the armature 40 drops. By means of the return spring 46, the bolt 42 is brought into an initial position. Here, the chamfer 30 of the bolt 42 slides onto the thickening 31 and effects a retraction of the catch element 5 in the direction of the housing 10. This results in a release of the piston head 24 by lifting the latches 51 out of the catch receptacles 10, 20a, 20b. The piston 24 can then be freely moved in the housing 10, that is, in the axial direction of the housing 10. Excessively deep advancing of the piston rod 23 is prevented by the stop element 26.

The FIGS. 5 and 6 show a locking unit 1 as described in connection with FIG. 4. Illustrated in each case are different positions as already analogously described in connection with the FIGS. 1 to 3. While the FIGS. 4 and 5 show the catch element 5 in engagement with the piston head 24, FIG. 6 shows the entire locking unit 1 in the de-energized state of the electromagnet 4 and the catch element 5 or the latch 51 arranged thereon in a release position of the piston head 24, that is, the latches 51 are not in engagement with the catch receptacles 20, 20a, 20b.

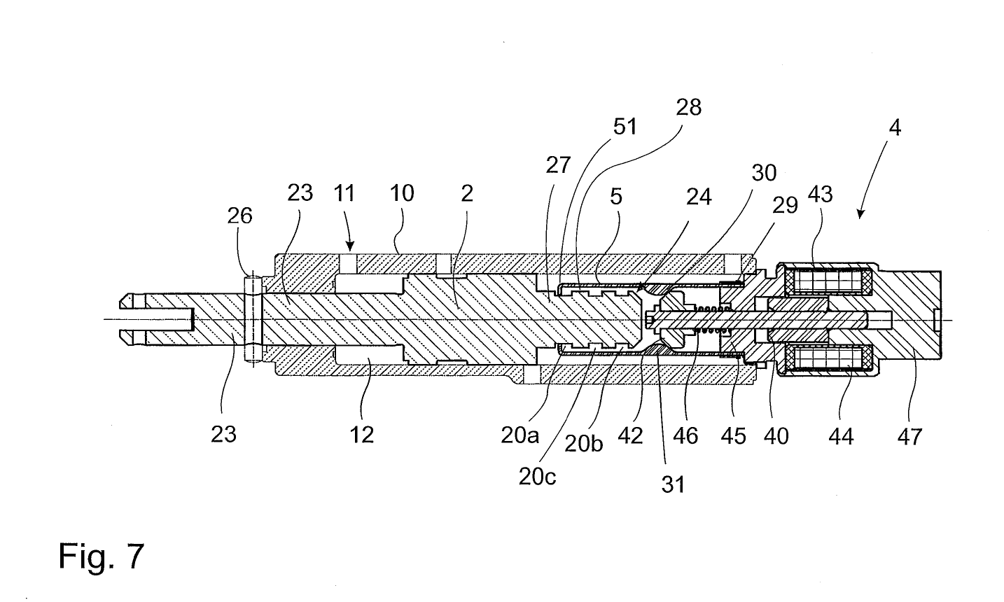

FIG. 7 shows another possible embodiment of the locking unit 1 according to the invention; in addition to the catch receptacles 20, 20a, 20b already described in connection with the preceding figures, the piston head 24 in the exemplary embodiment has another catch receptacle 20c and thus enables an additional catch position for the latches 51 of the catch elements 5. Apart from that, the functionality and effect of the locking unit 1 is identical to that described in connection with the preceding figures. In the exemplary embodiment of the FIGS. 4 to 7, the latches 51 are moved radially inwards while in the exemplary embodiments of the FIGS. 1 to 3, a movement of latches 51 is provided that is directed radially outwards, that is, a radial movement towards the housing 10.

Another embodiment of the locking unit 1 according to the invention is schematically illustrated in the FIGS. 8 to 11. Here too, the locking unit 1 has a piston 2. For clarity reasons, the individual components of the piston are reduced here to only those components that are relevant for the description of the embodiment. The electromagnet 4 provided in the embodiment is configured as described in connection with the preceding figures and shows no deviations with respect thereto. Here too, the armature 40 reacts to a magnet field. When switching on the current through the coil winding of the coil 44, a magnetic field is formed in which the armature 40 tries to orient itself. In the exemplary embodiment shown in FIG. 8, the current flow is switched on, the armature 40 is displaced to the right against the force of the return spring 46 and a possible air gap between the armature 40 and the core 47 is closed. The bolt 42 which is shaped like a bolt ring, as illustrated in the FIGS. 8 to 10, is attached on the armature rod 41. The ring-like bolt 42 interacts with the cam 80 provided on the catch element 5. In the activated position of the locking unit illustrated in FIG. 8, thus with current applied to the coil 44, the bolt 42 is shifted by the armature rod 41 in such a manner that the catch elements 5 or the latch 51 attached thereto is lifted out of the locking position. Thus, in the energized state of the electromagnet 4, unlocking of the piston takes place so that the latter is movable.

The catch receptacle 20 is provided as a ring-shaped recess in the piston head 24. This can be achieved, for example, by a concentric milling operation. Through this, the catch receptacle is provided. The piston head 24 provides another catch receptacle 20 that is spaced apart from the first catch receptacle 20. Here, the catch receptacle 20 is produced in that step-like milling is carried out on the piston head 24. The remaining material now provides the catch receptacle 20.

In FIG. 9, another locking position of the locking unit 1 is shown. The position of the piston 2 is identical to that shown in FIG. 8. The electromagnet in FIG. 9 is shown in the de-energized state. As a result, the armature drops off the core 47 and due to the reset force of the return spring 46, displacement of the armature 40 and the armature rod 41 arranged thereon takes place. By means of the return spring 46, the bolt 42 is moved away from the electromagnet 4 in the axial direction. In doing so, the bolt 42 or the shell surface thereof slides onto the cam 80 which results in a radially outwards directed movement of the catch element 5. Through this, engagement of the latch 51 in the catch receptacle 20 is achieved and a first locking position of the piston 2 is taken. Due to the configuration of the catch receptacle 20 in which the latch 51 engages, the piston 2 cannot be moved farther towards the electromagnet 4. Rather, the piston 2 remains in the locking position as illustrated in FIG. 9. Axial movement of the piston 2 away from the electromagnet is still possible.

FIG. 10 shows a second possible position of the piston 2. In the exemplary embodiments of the FIGS. 10 and 11, the piston is displaced axially in the direction towards the electromagnet. In this exemplary embodiment, the catch element 5 or the latch 51 thereof is positioned in the region of the second catch receptacle 20. In the state illustrated in FIG. 10, the electromagnet 4 is energized, as a result of which—as already described—the return spring 46 is compressed due to the movement of the armature rod 41. In this case, the bolt 42 is not in engagement with the cam 80 on the catch element 5; thus, the latch 51 is lifted out of the locking position and does not lie in the catch receptacle 20 or the projection providing the catch receptacle 20 inside the piston head 24. This position or unlocking position allows unhindered displacement or movement of the piston 2 in the axial direction. During energization of the electromagnet, the bolt 42 and thus also the catch element 5 remains in the position illustrated in FIG. 5.

The return spring 46 is compressed by the displacement of the armature 40 and the armature rod 41 arranged thereon. This also takes place by means of the bolt 42 which provides support for the return spring 46. In order to prevent that displacement of the bolt 42 takes place due to the reset force of the compressed spring 46, a circumferential edge 90 or projection is provided on the armature rod 41, against which circumferential edge the bolt 42 rests. This circumferential edge 90 prevents displacement of the bolt 42. At the same time, the circumferential edge 90 drives the bolt 42 upon energization of the electromagnet 4 and thus effects compression of the return spring 46.

If, as illustrated in FIG. 11, energization of the electromagnet 4 is terminated, the armature 40 drops from the core 47 and the return spring 46 effects displacement of the armature 40 or the armature rod 41 in the axial direction. In the process of this, the conically formed bolt 42 is pushed onto the cam 80 on the catch element 5 or slides thereon and effects a radially outwardly directed movement of the catch element 5, whereupon the latch 51 is brought into engagement with the catch receptacle 20 provided in the bolt head 24. The catch element 5 is hinged in the yoke 45 and due to the elasticity of the catch element 5, it can deflect out of the locking position during the displacement of the bolt 42 caused by the energization of the electromagnet 4 and thus can release the piston 2.

The embodiment of the locking unit 1 illustrated in the FIGS. 8 to 10 thus allows locking of the piston 2 in the de-energized state of the electromagnet 4. In contrast, releasing the piston takes place by energizing the electromagnet 4 and the resulting armature movement.

In addition to the embodiments shown in the FIGS. 1 to 7, thus, another embodiment of the locking unit 1 is provided which enables reliable locking or unlocking of the piston 2 or of a parking lock.

The claims submitted with the present application and submitted at a later time are without prejudice for obtaining further protection. If a more detailed examination, in particular also of the relevant prior art, should result in that the one or the other feature is advantageous but not of decisive importance for the object of the invention, a formulation that no longer includes such a feature, in particular in the main claim, is of course already endeavored. Such a subordinate combination is also covered by the disclosure of this invention.

Furthermore, it is to be noted that the configurations and variants of the invention described in the different embodiments and shown in the figures can be combined with each other in any desired way. Individual features or a plurality of features are interchangeable as desired. These feature combinations are also disclosed.

The references given in the dependent claims refer to the further development of the subject matter of the main claim by the features of the respective sub-claim. However, they are not to be understood as a disclaimer of obtaining an independent objective protection for the features of the related sub-claims.

Features disclosed only in the description, or individual features from claims that comprise a plurality of features, can be incorporated at any time in the independent claim/claims as being of essential importance for the invention and for limitation against the prior art, even if such features are mentioned in connection with other features or achieve particularly favorable results in connection with other features.

1. A locking unit for locking motion of a piston that can be moved by a drive comprising:
an electromagnet and at least one catch element, wherein the catch element interacts with (a) an armature or an armature rod of the electromagnet or (b) with a bolt or a bolt ring that is (i) retained by the armature or the armature rod or (ii) arranged on the armature or armature rod, and wherein
the piston has at least two catch receptacles located, respectively, at a distance from each other, and wherein
the piston is arranged to be fixed in different positions of the piston by the stopping interaction of the catch element with each of the respective catch receptacle.

2. The locking unit according to claim 1, wherein the catch receptacles are arranged axially spaced apart on the piston, and the piston has an axial extention aligned in an acting direction of the electromagnet and wherein the axial extention receives the catch receptacles.

3. The locking unit according to claim 2, wherein (a) the extension is formed as a separate element that is (i) arranged to be connected to the piston or (ii) defines an element that is integrally connected with the piston, or (b) the extension is formed as a catch sleeve having an inner shell surface, and the catch receptacles are provided as recesses or (c) the extension is formed as an axially extended piston head having an outer shell surface, wherein the catch receptacles are provided as recesses that are incorporated in the piston head or the outer shell surface.

4. The locking unit according to claim 1, wherein the catch element is at least one of (a) formed as a resiliently mounted tongue that extends in the axial direction into the piston at least up into the region of the catch receptacles and (b) formed to be elastically deformable.

5. The locking unit according to claim 1, wherein a free end of the catch element that is closest to the catch receptacles, and further comprising at least one latch-like bending that at least one of (a) extends radially in the direction of the catch receptacles, (b) is formed to be flat, and (c) defines length that corresponds substantially to depth of the catch receptacles and the catch element has a preload which, viewed relative to a longitudinal axis of the piston, is directed radially outwards or radially inwards.

6. The locking unit according to claim 1, wherein, when the electromagnet is de-energized, the bolt or the bolt ring is arranged to be positioned so that the catch element is movable from a locking position into an unlocking position, and when the electromagnet is energized, the bolt or the bolt ring is arranged to act onto the catch element so that the catch element is movable from the unlocking position into the locking position.

7. The locking unit according to claim 1, wherein, when the electromagnet is energized, the bolt or the bolt ring is arranged so that the catch element is movable from a locking position into an unlocking position, and when the electromagnet is de-energized, the bolt or the bolt ring is arranged to act onto the catch element so that the catch element is movable from the unlocking position into the locking position.

8. The locking unit according to claim 1, further comprising a return spring associated with at least one of the bolt, the bolt ring and the armature rod and effects a reset of at least one of the bolt and the armature into the locking position of the catch element when the electromagnet is de-energized, and the return spring is arranged to be compressed by movement of the armature when the electromagnet is energized, and in an energized state, the return spring introduces a reset force into the armature, wherein the reset force is directed in an axial direction away from the electromagnet.

9. The locking unit according to claim 1, wherein, in a first catch position, an axial movement of the piston towards the electromagnet is blocked, and in a second catch position, an axial movement of the piston away from the electromagnet is selectively blocked.

10. The locking unit according to claim 1, wherein the bolt or the bolt ring has a circumferential projection or flange that is movable into operative connection with a cam arranged on the catch element.

11. The locking unit according to claim 5, wherein the return spring is supported on a first side on the electromagnet or on or in a yoke of the electromagnet (4), and on a second, opposing side on the bolt, the bolt ring or a projection or flange on the bolt or the bolt ring, and the armature rod has a circumferential edge against which the bolt or the bolt ring rests, and the bolt or the bolt ring has a bolt tip that tapers conically in a direction of the armature rod, wherein the conically tapering bolt tip rests against a surface, and a movement of the bolt tip via at least a portion of the surface in an axial direction of the locking unit is selectively converted into a movement of the catch element, and wherein the movement, with respect to a longitudinal axis of piston, is directed radially outwards.

12. The locking unit according to claim 11 wherein the catch element provides a surface that is in operative connection with the bolt or the bolt ring, and upon movement of the bolt or the bolt ring in the axial direction of the locking unit, the catch element or the latch-like bending is movable radially on or via a surface into or out of the catch receptacle, and the catch element has a thickening that is formed conically and that is movable into engagement on the bolt or the bolt ring or on the bolt tip, wherein a relative movement of bolt, the bolt ring or the bolt tip and the thickening is adapted to be selectively converted into a radial movement of the catch element the latch-like bending, wherein at least one of (a) a radial movement, with respect to the longitudinal axis of the piston, is directed radially outwards against a preload of the catch element, (b) the catch element is resiliently hinged in the locking unit, and (c) a hinge point is provided on the electromagnet that extends into the locking unit or on a yoke that closes the electromagnet in a direction of the locking unit.

13. The locking unit according to claim 12, wherein the latch-like bending extends radially towards the piston center or radially away from the piston center.

14. The locking unit according to claim 12, wherein a movement of the bolt, the bolt ring or the bolt head is arranged to be converted into a radial movement of the catch element, and the latch-like bending is arranged to move, in dependence of the preload of the catch element, from a locking position into a release position or from a release position into a locking position, and the return spring is arranged to act against movement of the armature and is associated with the bolt or the bolt ring, and the bolt or the bolt ring is arranged so that, in a locking position and due to the movement of the armature in an axial direction in response energizing the electromagnet, the catch element is arranged to be pressed by the bolt or the bolt ring into the catch receptacles.

15. A transmission having a parking lock with a locking unit according to claim 1.

16. The transmission according to claim 15, wherein the transmission comprises an automatic transmission.

17. The locking unit according to claim 2 wherein the axial extension defines a piston head.

18. The locking unit according to claim 3, wherein the recesses comprise ring grooves or half-ring grooves that are incorporated in the inner shell surface, and wherein the catch sleeve is provided by a separate element attached to the piston or as a blind hole centrically drilled into the piston or the piston head.

19. The locking unit according to claim 4, wherein the catch element is formed at least one of (a) from spring steel, (b) to be rigid or elastic, and with or without preload, and (c) as two or more catch elements that are coaxial with the bolt, the bolt ring or the piston.

20. The locking unit according to claim 10, wherein the circumferential projection or flange is formed conically.
